(19) United States
(12) Patent Application Publication
(10) Pub. No.: US 2008/0096553 A1
(43) Pub. Date: Apr. 24, 2008

(54) MOBILE COMMUNICATION NETWORK

(75) Inventors: Vikram Saksena, Acton, MA (US); Ashish Nagpal, Kundalahalli (IN)

Correspondence Address: PROSKAUER ROSE LLP, ONE INTERNATIONAL PLACE, BOSTON, MA, 02110, US

(73) Assignee: Sonus Networks, Inc., Westford, MA (US)

(21) Appl. No.: 11/870,286

(22) Filed: Oct. 10, 2007

Related U.S. Application Data
(60) Provisional application No. 60/862,353, filed on Oct. 20, 2006.

(51) Int. Cl. H04Q 7/20

(52) U.S. Cl. 455/426.2

(57) ABSTRACT

The description generally provides for systems, methods, and computer readable media for creating a unified wireline/wireless communication network. Data is received that includes a signaling portion and a media portion. The signaling portion is separated into a first set of data and a second set of data. The first set of data includes mobile management functions and the second set of data includes features, applications related functions, or any combination thereof.

### CROSS-REFERENCES TO RELATED APPLICATIONS

This non-provisional patent application claims priority to and the benefit of U.S. Provisional Application No. 60/862,353, filed Oct. 20, 2006, titled “Wireless Handset Communication Network,” the disclosure of which is incorporated herein by reference.

### TECHNICAL FIELD

This description relates generally to computer-based methods and apparatuses, including computer program products, for a mobile communication network.

### BACKGROUND

With the increased use of cellular phones and cellular technology, low-power femto cell and pico cell access points are being used as alternative ways to connect a mobile handset to macro cellular networks. Both femto and pico cells are small-scale versions of the traditional cellular base stations that provide access for mobile handsets. They are similar to, for example, the Base Station Transceiver (BST) of the Base Station System (BSS) of a Global System for Mobile Communications (GSM) network, which is responsible for handling traffic and signaling between a mobile phone and the Network Switching Subsystem (NSS). Femto cells are considerably more limited in power than pico cells, designed to work in small spaces such as a user's home. Pico cells, however, can cover up to 30,000 square feet, being suitable for office-type applications. Femto cells and pico cells can operate in any of the four primary GSM bands at 850 MHz, 900 MHz, 1800 MHz, and 1900 MHz.

These two technologies connect through a Cat-5 cable to an IP network for backhaul transport. Just like the Base Station Controller (BSC), which provides the intelligence behind the BST, both pico and femto cell systems use a BSC to manage the flow of traffic to each pico cell and back, which essentially couples the in-building network to the carrier's broader network.

Most solutions bridging unlicensed IP-based broadband access networks with core mobile networks, such as GSM, combine the broadband network with the infrastructure of the mobile core network through a passive relay. Most functionality of the core mobile network, such as charging, authentication, and end-user administration is utilized from the core mobile network. This results with a system in which all traffic to and from the femto and pico cells are simply packaged up to be transported over the IP backhaul, typically through an IP wireline core network that is separate from the wireless network.

### SUMMARY

Advantageously, the techniques described herein provide a unified core network, independent of the wireless network, which facilitates the separation of mobility management and services. Services are provided by the core network independent of the nature of their access (e.g. wireleine or wireless), and mobility aspects can be handled prior to providing service. The core network (e.g. a SIP/IMS network) serves mobile subscribers connected through pico/femto cells. A user can connect through a low-power GSM network and roam out to the macro network, and the call is handed over to the MSC without being disconnected. The core network can serve wireline subscribers and the wireless access node allows service to wireless subscribers, resulting in a converged wireline/wireless core network.

In one aspect, there is a method of creating a unified wireline/wireless communication network. The method includes receiving data that includes a signaling portion and a media portion. The method further includes separating the signaling portion into a first set of data and a second set of data, wherein the first set of data includes mobility management functions and the second set of data includes features, applications related functions, or any combination thereof.

In another aspect there is a computer program product, tangibly embodied in an information carrier, the computer program product including instructions being operable to cause a data processing apparatus to receive data that includes a signaling portion and a media portion. The computer program product further includes instructions being operable to separate the signaling portion into a first set of data and a second set of data, wherein the first set of data includes mobility management functions and the second set of data includes features, applications related functions, or any combination thereof.

In another aspect there is a system for creating a unified wireline/wireless communication network, the system including an access node configured to receive data that includes a signaling portion and a media portion. The system further includes a wireless network adapter configured to separate the signaling portion into a first set of data and a second set of data, where the first set of data includes mobility management functions, and where the second set of data includes features, applications related functions, or any combination thereof.

In another aspect there is system for creating a unified wireline/wireless communication network, the system including a means for receiving data that includes a signaling portion and a media portion. The system further includes a means for separating the signaling portion into a first set of data and a second set of data, where the first set of data includes mobility management functions, and where the second set of data includes features, applications related functions, or any combination thereof.

In another aspect there is a system for creating a unified wireline/wireless communication network, the system including an access node configured to receive data that includes a signaling portion and a media portion. The system further includes a wireless network adapter configured to receive the signaling portion of the data and to split the signaling portion into a first set of data and a second set of data, where the first set of data includes mobility management functions, and where the second set of data includes features, applications related functions, or any combination thereof, the wireless network adapter using mobile wireless network communication functionality.

Any of the aspects above can include one or more of the following features. The data can be received over a network. A base station can be in communication with the network, and the base station include a picocell or femtocell base station. The network can be an IP network. The first set of data can be transmitted to a mobile wireless network using a protocol associated with a wireless telecommunication standard. The protocol associated with the wireless telecommunication standard can include GSM-MAP, CDMA IS-41, or any combination thereof.

The mobile wireless network can be a GSM network. The second set of data can be transmitted to a core network using a protocol associated with a packet communication technology. The protocol associated with the packet communication technology can include SIP, RTP, UMTS, AMR, or any combination thereof. The core network can emulate cellular core network components towards an external network. The core network can support a service provided by a mobile communication network, the services including call forwarding, call waiting, call hold, call parking, simultaneous ringing, call transfer, multi-party calling, voice mail notification, emergency calling, call completion busy, call barring, or any combination thereof.

A component of the core network can be a HLR proxy server that implements traditional HLR functionality and additional functionality to support the core network. The additional functionality can include collecting data from a mobile wireless network location register, storing mapping information between incompatible data formats, providing data mapping to other components of the core network, keeping data of a data server associated with the central network in sync with data from a mobile wireless network location register, or any combination thereof. The mobile wireless network location register can include an HLR, VLR, or any combination thereof.

The media portion can be transmitted to a server using packet communication technology. The media portion can include voice portions of the data, inband tones of the data, other functions that are communicated across the telephone communication network to a media gateway, or any combination thereof. At least a portion of the mobile wireless network can be configured to receive a first set of data from the wireless network adapter, the at least portion of the mobile wireless network being in communication with the wireless network adapter using a protocol associated with a wireless telecommunication standard. At least a portion of a core network configured to receive a second set of data from the wireless network adapter, the at least portion of the core network being in communication with the wireless network adapter using a protocol associated with a packet communication technology. The wireless network adapter can be further configured to transmit the first set of data to a mobile wireless network and transmit the second set of data to a core network.

A media gateway can be configured to receive the media portion of the data, generate a third set of data, and transmit the third set of data to a telephone communication network in communication with the media gateway using a protocol associated with a packet communication technology. The third set of data comprises voice portions of the data, inband tones of the data, other functions that are communicated across the telephone communication network to a media gateway, or any combination thereof. The wireless network adapter can be further configured to work with at least a portion of a core network to emulate a MSC and a VLR. Mobile wireless network communication functionality can include MSC, HLR, VLR, AUC, TRAU, IWF, SGSN, GGSN, BSC, BTS, or any combination thereof.

Any of the aspects above can include one or more of the following advantages. The techniques described herein enable the use of an alternate low power access network, such as a small, low-price in building base station communicating over IP to the core network. For example, the subscriber can use a low-power GSM network within a building and use a partner Macro GSM network when outside. The system is easy for the customer to use since no new user behavior is required, and all existing GSM handsets can be supported. Advantageously, mobile services can be provided in a local or remote area, such as on a campus or cruise ship. A complete set of capabilities can be provided to service providers that have low-power GSM licenses, which enable companies to set up mini cell sites and offer GSM services in buildings and other localized areas.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram of an exemplary converged wireless/wireline networking system.

FIG. 2 is a block diagram of the network interactions with an access node.

FIG. 3 is a block diagram of the access node components and core network components.

FIG. 4A and FIG. 4B are sequence diagrams of a location update when the communication device powers on in the home network.

FIG. 5 is a sequence diagram of a location update when the communication device roams into the home network.

FIG. 6A and FIG. 6B are sequence diagrams a mobile origination call.

FIG. 7 is a block diagram of a mobile subscriber to mobile subscriber call.

FIG. 8A-FIG. 8C are block diagrams of an intra-switch handover.

FIG. 9A-FIG. 9C are block diagrams of an inter-switch handover.

FIG. 10 is a sequence diagram of a call forward invocation.

FIG. 11 is a block diagram of call waiting.

FIG. 12 is a block diagram of call hold.

### DETAILED DESCRIPTION

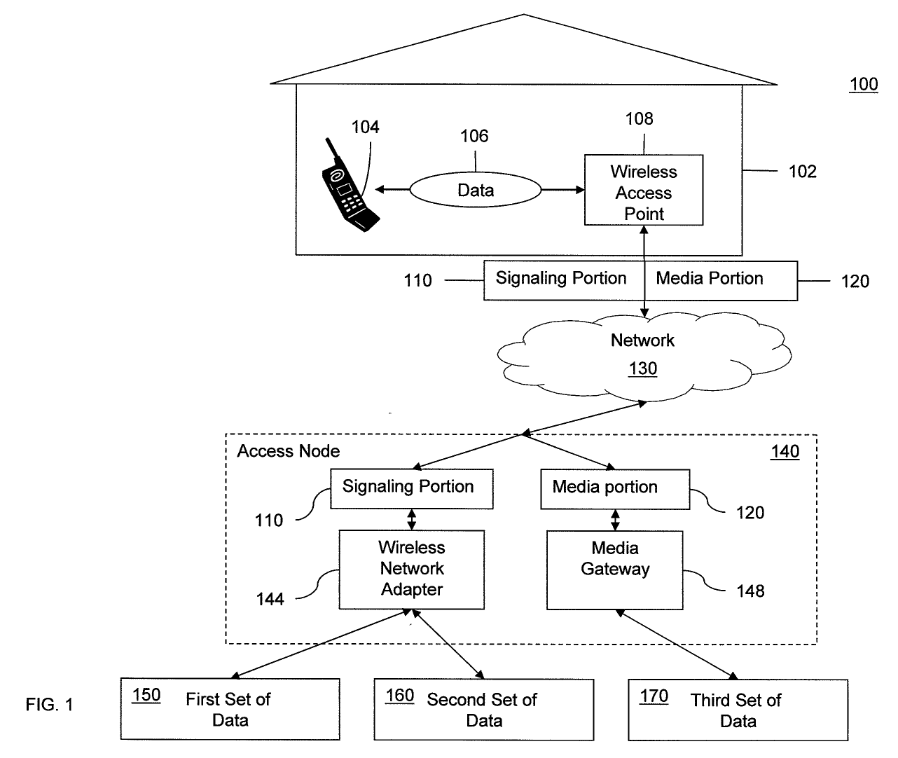

FIG. 1 is a diagram of a communication network 100 which includes a local wireless communication network 102 that communicates with an access node 140 through a network 130. The network 130 can be the Internet, an intranet, an internet protocol (IP) network, an asynchronous transfer mode (ATM) network, a proprietary network, such as a cable television network, a fiber-to-the-house network, such as the Verizon FIOS® network, or a wireless network, such as a satellite network or 802.16 WiMax network, and/or the like. The local wireless communication network 102 includes a wireless communication device 104, data 106 (e.g., a transmission of data), and a wireless access point 108. The wireless communication device 104 can be, for example, a wireless handset. The data 106 can be a voice communication, data communication, short message service (SMS) communication, an image transfer, still or video, and/or the like. The wireless communication device 104 can transmit the data 106 in a format that conforms with any number of wireless telecommunication standards, such as a general packet radio service (GPRS) standard, a global system for mobile communication (GSM) standard, an enhanced general packet radio service (EDGE) standard, a code division multiple access (CDMA) protocol, a code division multiple access 2000 (CDMA2000) standard, a time division multiple access (TDMA) protocol, a frequency division multiple access (FDMA) protocol, an international mobile telecommunications-2000 (IMT-2000) standard, a personal digital cellular (PDC) standard, a circuit switched data (CSD) protocol, an 802.11 standard, and/or the like.

The information, e.g., a transmission of data, the network 130 receives includes a signaling portion 110 and a media portion 120. The media portion 120 includes, for example, the voice portions of the data, the inband tones of the data, other functions that are communicated across telephone communication networks to a media gateway, and/or the like. The media portion 120 can be compliant with AMR, RTP, G.711, and/or the like.

The access node 140 processes the signaling portion 110 into a first set of data 150 and a second set of data 160. The access node 140 includes a wireless network adapter 144 and a media gateway 148. The wireless network adapter 144 generates the first set of data 150 and a second set of data 160. The first set of data 150 includes mobile management functions, which includes, for example, call control messages, the mobile switching center (MSC) location procedures, the MSC handover procedures, short message service (SMS) procedures and messages, media establishment and teardown, and other functions that are communicated across telephone communication networks related to management of mobile subscribers. The wireless network adapter 144 formats the first set of data 150 for use in a mobile wireless network, which includes, for example, an integrated digital enhanced network (iDEN), high-speed circuit-switched data (HSCSD) network, a personal communication service (PCS) network, a global system for mobile communication (GSM) network, a general packet radio service (GPRS) network, an enhanced general packet radio service (EDGE) network, a code division multiple access (CDMA) network, a time division multiple access (TDMA) network, a frequency division multiple access (FDMA) network, a personal digital cellular (PDC) network, a circuit switched data (CSD) network, and/or the like. The wireless network adapter 144 transports the first set of data 150 via an interface (e.g. GSM-MAP, ANSI IS-41, or CAMEL) to an HLR, MSC, SMSC, SCP and/or the like. The access node 110 can perform MSC procedures (e.g. location management, call establishment, call teardown, or SMS).

The second set of data 160 includes features and/or applications related functions. These functions can include, for example, call forwarding, call waiting, call hold, call parking, simultaneous ringing, call transfer, multi-party calling, voice mail notification, emergency calling, call completion busy, call barring, and other similar services. The wireless network adapter 144 formats the second set of data 160 using data packet technology such as, for example, SIP.

The wireless access point 108 receives data 106 from a wireless communication device 104. The wireless access point 108 can be, for example, a pico/femto cell. The wireless access point 108 encapsulates the data 106 into a format that conforms to a particular protocol used by the network 130. The particular protocol can include IP, TCP, VoIP, UDP, and/or the like. The wireless access point 108 can, for example, constitute a base station that transmits and receives signals over a wireless network using a mobile technology and processes the data 106 for transmission over a data network 130. Both the signaling portion 110 and media portion 120 are communicated to the access node 140 over the network 130.

For example, the data 106 is processed for transmission over a network 130 so that a wireless access point 108 located at a user's home can be connected to the user's broadband internet connection. The data 106 that includes the signaling portion 110 and media portion 120 can, for example, be encapsulated and/or converted into IP for transmission across the network 130 to the access node 140.

The signaling portion 110 is received by the wireless network adapter 144, which de-capsulates, reformats, and/or transforms the signaling portion 110 into a first set of data 150 and a second set of data 160. The first set of data 150 is transmitted to a mobile wireless network, and the second set of data 160 is transmitted to a core network. The media gateway 148 receives the media portion 120 and transmits that media portion 120 to servers located on a packet portion of a telecommunications network. The media gateway 148 may also perform transcoding, such as, for example, converting an AMR signal to a G.711 signal.

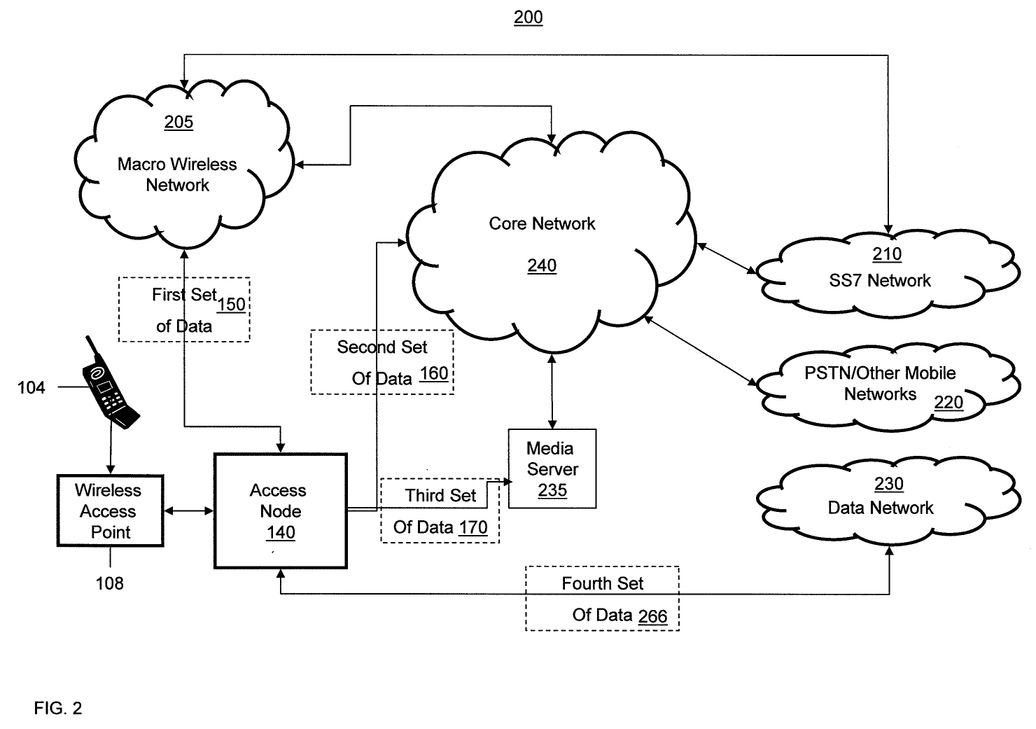

FIG. 2 is a block diagram of a converged wireline/wireless network 200, showing an example of how FIG. 1 components are incorporated with other types of networks. The wireless communication device 104 is in communication with the wireless access point 108. The access node 108 is in communication with the macro wireless network 205, the core network 240, media server 235, and the data network 230. The macro wireless network 205 can be, for example, a GSM network, a CDMA network, or a cellular network. The macro wireless network 205 can be accessed through, for example, a GSM softswitch (not shown), such as the Zynetix Ltd. SoftMSC. The access node 140 communicates the first set of data 150 to the macro wireless network 205. The communication protocol between the access node 140 and the macro wireless network 205 can be, for example, MAP over a D or E interface. The access node 140 communicates the second set of data 160 to the core network 240. The second set of data 160 can be formatted using, for example, SIP. The access node communicates the third set of data 170 to a media server 235 using, for example, G.711/RTP. The media server 235 communicates with the core network 240 using, for example, SIP. The media server 235 can, for example, transmit voice prompts to the media gateway 148. The access node 140 communicates the fourth set of data 266 to the data network 230. The data network 230 can be, for example, a GPRS network, and the fourth set of data 266 can be GPRS data.

The core network 240 is in communication with the PSTN/other mobile networks 220 using, for example, TDM. The core network 240 can be a SIP/IMS core network. The PSTN/other mobile networks 220 can include, for example, an iDEN network, HSCSD network, GPRS network, EDGE network, CDMA network, TDMA network, FDMA network, PDC network, CSD network, and/or the like. The core network 240 is in communication with the macro wireless network 205 using MAP, for example. The core network 240 is in communication with the Common Channel Signaling System No. 7 (SS7) Network 210 using, for example, a signaling gateway to communicate telephony signaling protocols used to set up PSTN phone calls.

The wireless access point 108 can receive a communication from the wireless communication device 104 and processes the communication. The communication includes a signaling portion 110 and a media portion 120. The wireless access point 108 transmits the communication over the network 130 to the access node 140. The signaling portion 110 is processed by the access node 140 into the first set of data 150 and the second set of data 160 by, for example, de-capsulating the signaling portion 110, reformatting the signaling portion 110, and/or the like. The first set of data 150 is formatted for use in the macro wireless network 205, and the access node 140 transmits the first set of data 150 to the macro wireless network 205. The second set of data 160, is formatted using SIP and the access node 140 transmits the second set of data 160 to the core network 240. The media portion 120 can be formatted into the third set of data using transcoding. In some exemplary embodiments, the media portion 120 is converted from an AMR signal to a G.711 signal and transmitted to servers located on a packet portion of a telecommunications network, such as the media server 235. The fourth set of data 266, which includes, for example, GPRS data, is transmitted to the data network 230.

For a mobile origination or mobile termination call to the PSTN, the core network 240 contains, for example, a gateway switch to handle communication with the PSTN/other mobile networks 220. Circuit-based signaling to and from the PSTN and can be, for example, communicated by a signaling gateway within the core network 240 to the SS7 network 210. Advantageously, the core network 240 can, for example, provide call routing, provide supplementary services, interface (e.g. using MAP) with a HLR, and interface (e.g. using CAP) towards a SCP. The access node 140 can, for example, emulate a MSC, provide procedures related to location updating and handovers, provide VLR functions, implement interfaces (e.g. D/E, A(BSSAP) or A/IP interface), and control media flow.

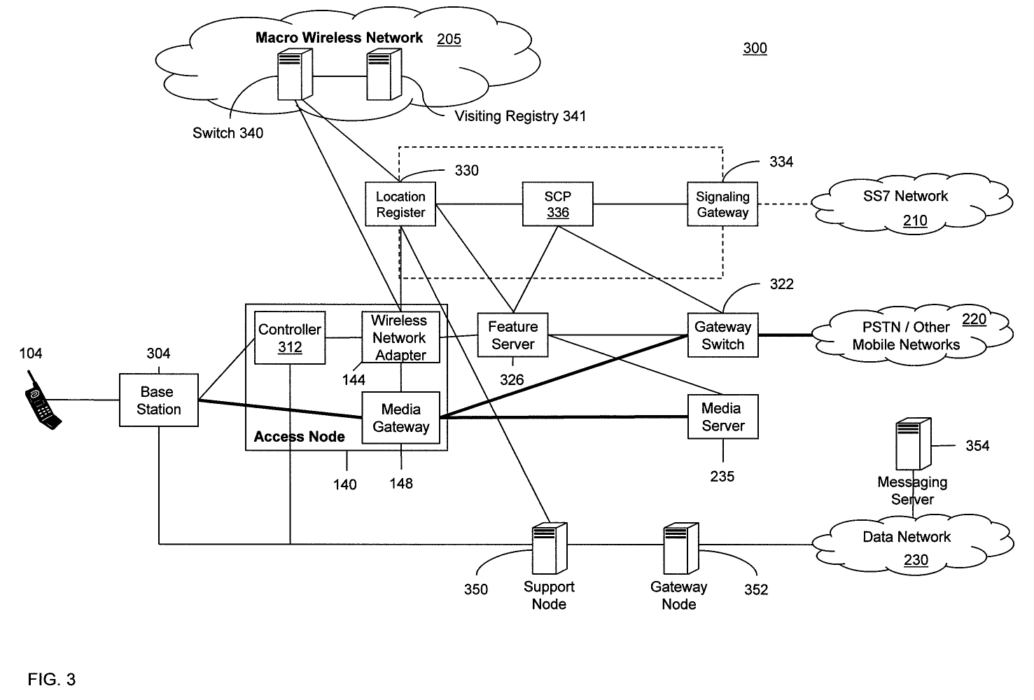

FIG. 3 is a more detailed block diagram of an access node network architecture 300 that illustrates an embodiment incorporating some of the previously described components from FIG. 1 and FIG. 2. The core network 240 includes a gateway switch 322, a feature server 326, a location register 330, the media server 235, and a signaling gateway 334. The access node includes the controller 312, the wireless network adapter 144, and the media gateway 148.

The media gateway 148 communicates with the gateway switch 322 and the media server 235 using, for example, G.711/RTP. The gateway switch 322 handles media to and from the public switched telephone network (PSTN). This can be, for example, a GSX® Open Service Switch available from Sonus Networks, Inc., the CVX® Multi-Service Access Switch from Nortel Networks, Inc, and/or the like. The media server 235 performs the Media Resource Function (MRF) and eases the delivery of subscriber-focused services and applications to carriers and service providers for better communications by enabling, for example, voice messaging, video messaging, conferencing, and video sharing solutions, and/or the like. An example is the SnowShore IP Media Server™ available from Cantata Technology, Inc.

The wireless network adapter 144 communicates with the feature server 326 using, for example, SIP. The feature server 326 handles call session states, including coordinating the use of application servers for enhanced services. The feature server 326 delivers IP-based consumer and small business (Class 5) VoIP call features over any access technology. The access technology can be, for example, voice-over-DSL, voice-over-WiFi and WiMax, voice-over-cable and Ethernet. The feature server 326 can be, for example, an ASX® Feature Server available from Sonus Networks, Inc. The wireless network adapter 144 communicates with the location register 330 using, for example, MAP over the D interface. The location register 330 is a central database of subscriber information, including, for example, the subscriber's service profile, their current status in the network, and/or the like. This can be, for example, an HSX® Home Subscriber Server available from Sonus Networks, Inc.

The location register 330 communicates with the SCP 336 using, for example, MAP over the D interface. The SCP 336 routes calls to the PSTN or any other circuit-based network, providing service selection and routing for VoIP and multimedia services across the application architecture. The SCP 336 can handle, for example, routing and provisioning. The location register 330 communicates with the feature server 326 using, for example, a web interface. The feature server 326 can include a database to store information (not shown). The database can be, for example, an ADS® Access Directory Server available from Sonus Networks, Inc. The gateway is in communication with the signaling gateway 334 which passes circuit-based signaling to and from the PSTN. The signaling gateway can be, for example, an SGX® Signaling Gateway available from Sonus Networks, Inc.

The Macro Wireless Network 205 could be any mobile communication network such as, for example, a GSM network. The switch 340 is a telephone exchange which provides, for example, circuit-switched calling, mobility management, mobile network communication services, and/or the like to the wireless communication device 104 within the area the switch 340 serves. The switch 340 is closely coupled with the visiting registry 341 and can be, for example, a mobile switching centre (MSC). The visiting registry 341 is a temporary database of the subscribers who have roamed into the particular area which it serves. One example is a visitor location register (VLR). The data stored in the visiting registry 341 can be received, for example, from the macro wireless network 205. The macro wireless network 205 can include a central database that contains details of each mobile phone subscriber that is authorized to use the mobile communication network. This can be, for example, a home location register (HLR).

The wireless communication device 104 connects through a base station 304. The base station 304 contains, for example, the equipment for transmitting and receiving radio signals, antennas, and equipment for encrypting and decrypting communications with the controller 312. The base station can be, for example, a femto cell, pico cell, base transceiver station (BTS), and/or the like. The base station 304 can communicate with the media gateway 148 using, for example, AMR, RTP, and/or the like. The base station 304 can communicate with the controller 312 using, for example, Abis/IP. The controller 312 provides the management and control functions for the base station 304 by allocating of radio channels, receiving measurements from mobile phones, controlling handovers, and/or the like.

The controller 312 communicates with the data network 230 through the support node 350 and gateway node 352. The data network can be, for example, a GPRS network. The support node 350 keeps track of the wireless communication device 104 and performs, for example, security functions, access control, and/or the like. One example is the Serving GPRS Support Node (SGSN). The support node 350 supports the gateway node 352 with services such as, routing, filtering, billing, and/or the like. One example is the Gateway GPRS Support Node (GGSN). The data network 230 interacts with the messaging server 354, which transfers messages, provides operations specific to the mobile environment, provides storage services, and/or the like. This can be, for example, a multimedia messaging service (MMS) Relay, MMS Server, and/or the like.

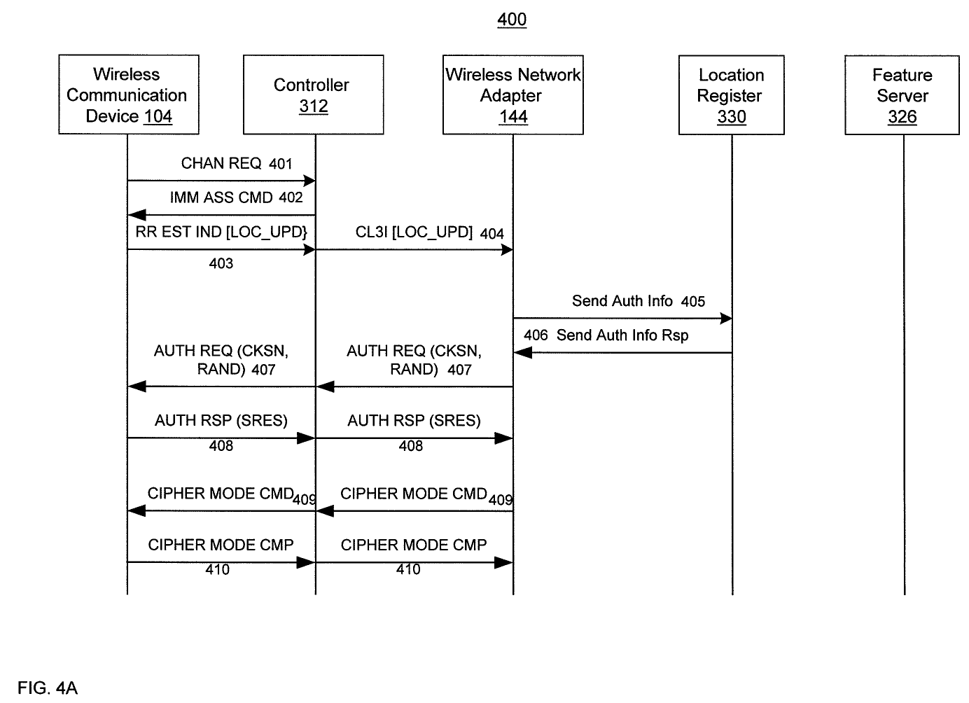

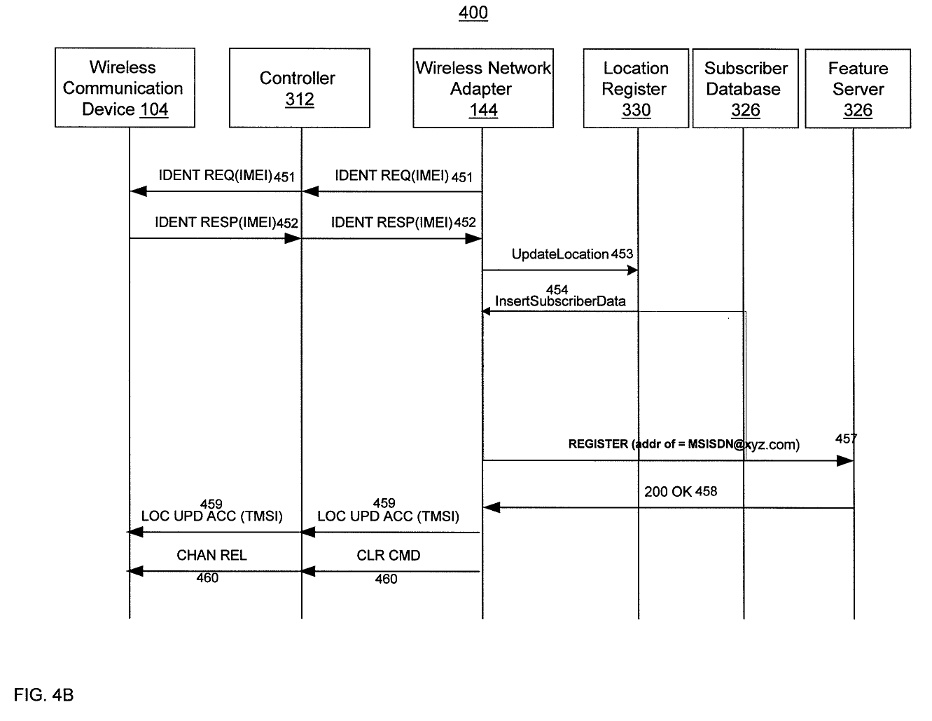

FIG. 4A through FIG. 18 further explore the interaction between the components of the access node network architecture 300 in conjunction with the local wireless communication network 102 as depicted in FIG. 1. FIG. 4A and FIG. 4B depict a process 400 illustrating the flow of events when a wireless communication device 104 powers on and registers in the local wireless communication network 102. This can be, for example, a location update without a previous VLR association. In the process 400 of FIG. 4A, the wireless communication device 104 sends a CHaNnel REQuired message 401 to the controller 312 to request a channel on the local wireless communication network 104. The controller 312 responds to the wireless communication device 104 with an IMMediate ASSignment CoManD 402, which can contain possible assignment commands such as immediate assignment, immediate assignment extended, immediate assignment rejected, and/or the like. This establishes a dedicated resource for the wireless communication device 104.

The wireless communication device 104 then responds with an RR ESTablish INDication message 403, which includes a LOCation_UPDate message, to the controller 312 (e.g. a BSC). The controller 312 passes the RR EST IND message 403 to the network adapter 144 using a Complete Layer 3 Information message 404, which is used to transport all initial messages by which a connection can be established. This message can contain, for example, a Location Area Code (LAC), cell identity, and/or the like. The wireless network adapter 144 sends a send AUTHentication INFOrmation message 405 to the location register 330 (e.g. a HLR or VLR) to request valid authentication data, and the location register 330 responds with a send AUTHentication INFOrmation ReSPonse message 406. The wireless network adapter 144 sends an AUTHentication REQuest (Ciphering Key Sequence Number, RANDom number) message 407 to the controller 312 during the connection setup to authenticate the wireless communication device 104, and the AUTH REQ (CKSN, RAND) message 407 is relayed to the wireless communication device 104 through the controller 312. The wireless network adapter 144, upon receiving the send auth info rsp message 406 from the location register 330, includes the RAND retrieved from the location register 330 and other authentication parameters, such as the CKSN, which need to be communicated to the wireless communication device 104.

The wireless communication device 104 computes the signed response (SRES) and sends the SRES back to the wireless network adapter 144 in the AUTHentication RESPonse (SRES) message 408, which is relayed through the controller 312. If the SRES received in the AUTHentication RESPonse (SRES) message 408 matches the one received from the location register 330, the wireless network adapter 144 initiates the ciphering procedure by sending a CIPHER MODE CoMmanD message 409 to the wireless communication device 104 through the controller 312. The wireless communication device 104 confirms that the CIPHER MODE CMD message 409 was received by sending the CIPHER MODE CoMPlete message 410 to the wireless network adapter 144, which is routed through the controller 312. At this point, encryption begins.

The process 400 is continued in FIG. 4B, where the wireless network adapter 144 sends an IDENTity REQuest (Internal Mobile Equipment Identity) message 451 to the wireless communication device 104 through the controller 312. This step is done if, for example, an equipment check feature is active in the wireless network adapter 144. Each wireless communication device 104 has its own IMEI, which is a unique identifier. The IMEI may contain, for example, a type approval code, a serial number, a final assembly code, a type identifier, and/or the like. The wireless communication device 104 communicates its IMEI back to the wireless network adapter 144 with an IDENTity RESPonse (IMEI) message 452, which is passed through the controller 312. The wireless network adapter sends an UpdateLocation message 453 to the location register 330, which allows the location register 330 to update stored information pertaining to the wireless communication device 104.

The location register 330 responds to the wireless network adapter 144 by sending all subscriber data to the wireless network adapter 144 using an InsertSubscriberData message 454. The InsertSubscriberData message 454 may contain, for example, a Mobile Subscriber ISDN (MSISDN), which is the directory number of the wireless communication device 104. This message is used to identify the servicing subscriber database 326, which may contain, for example, a subscriber database identifier. The wireless network adapter sends a REGISTER message 457 to the feature server 326 (e.g. an ASX), which contains, for example, the MSISDN of the wireless communication device 104. The feature server 326 responds with a 200 OK message 458, acknowledging receipt of the REGISTER message 457. The wireless network adapter 144 sends the LOCation UPDating ACCept (Temporary Mobile Subscriber Identity) message 459 to the wireless communication device 104 through the controller 312, where LOC UPD ACC (TMSI) message 459 confirms a successful location update and assigns a new TMSI.

When the service with the wireless communication device 104 is no longer needed, the wireless network adapter 144 sends a CLeaR CoMmanD message 460 to the controller 312 to release the radio resources. To complete the termination of service, the controller 312 sends a CHANnel RELease message 461 to the wireless communication device 104 to disconnect the connection to the wireless communication device 104. FIGS. 4A and 4B show how the wireless network adapter 144 performs MSC/VLR functions for location updating. For example, it keeps track of wireless communication device 104 locations, updates the location register 330 on a change of location area, and/or the like. SIP registration can be performed using, for example, the MSISDN, and the location register 330 provides the IMSI-MSISDN mapping. SIP registration keep-alive can be performed, for example, by the wireless network adapter 144. Advantageously, for example, services are provided by the core network as opposed to separate wireline and wireless core networks and mobility aspects are handled prior to providing service.

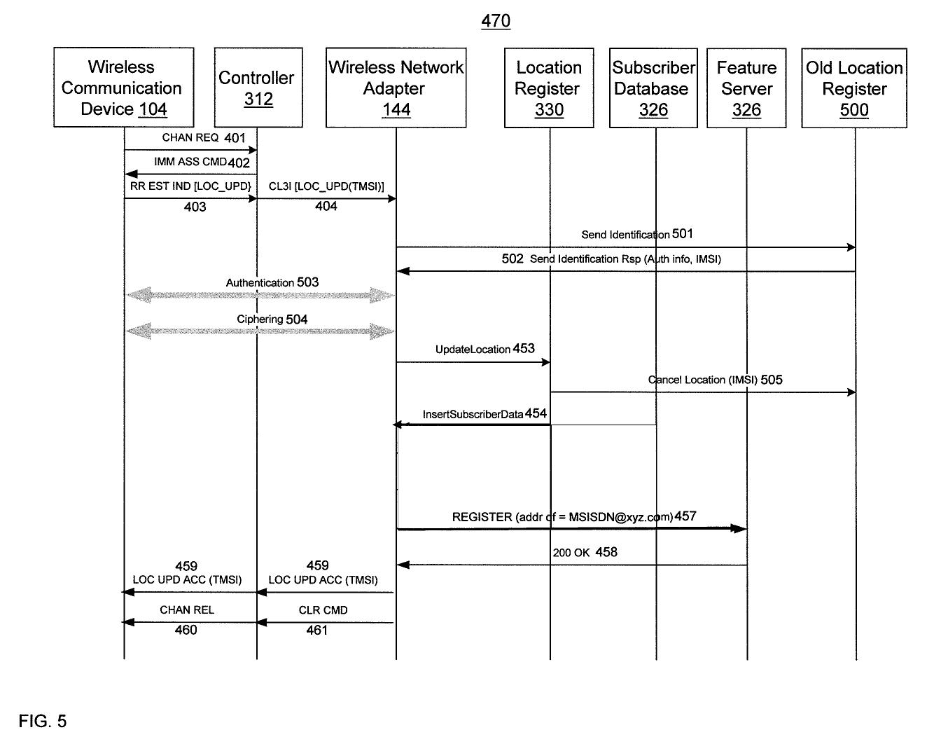

FIG. 5 depicts a process 470 illustrating components of the access node network architecture 300 of FIG. 3 when a wireless communication device 104 roams from an external network into a local wireless communication network 102 as depicted in FIG. 1. For example, a MS roaming into a home network from a visited network. Using similar steps as with FIG. 4A, the wireless communication device 104 sends a CHN REQ message 401 to the controller 312 (e.g. a BSC), and the controller 312 responds to the wireless communication device 104 with an IMM ASS CMD 402. The wireless mobile subscriber 104 then responds with an RR EST IND message 403, which is a LOC_UPD message, to the controller 312. The controller 312 passes the RR EST IND message 403 to the wireless network adapter 144 using the CL3I message 404. The controller 312 inserts, for example, the current LAC, Cell identity, and TMSI into the CL3I message 404. The wireless network adapter 141 can, for example, map the first location update from the wireless communication device 104 towards the feature server 326. Changes in location do not need to be communicated to the feature server 326 as long as the switch 340 of the macro wireless network 205 remains the same.

The wireless network adapter 144 requests the valid authentication data from the old location register 500 (e.g. an old VLR) in a Send Identification message 501. The old location register 500 replies to the wireless network adapter 144 with a Send Identification Response message 502 (Authentication Information, Internal Mobile Subscriber Identity) message 502, which can include, for example, authorization keys, the IMSI, and/or the like. Then authentication 503 and ciphering 504 occur as demonstrated in FIG. 4A. The wireless network adapter sends an UpdateLocation message 453 to the location register 330 (e.g. an HLR), which allows the location register 330 to update stored information pertaining to the wireless communication device 104. The location register 330 sends a Cancel Location (IMSI) message 505 to the old location register 500 to delete, for example, the stored subscriber data. The location register 330 sends all subscriber data back to the wireless network adapter 144, which contains, for example, the MSISDN.

The remaining steps follow the same steps as the process 400 in FIG. 4B. The wireless network adapter sends a REGISTER message 457 to the feature server 326, and the feature server 326 responds with a 200 OK message 458, acknowledging receipt of the REGISTER message 457. The wireless network adapter 144 sends LOC UPD ACC (TMSI) message 459 to the wireless communication device 104 through the controller 312. To end the wireless communication device 104 service, the wireless network adapter 144 sends the CLR CMD message 460 to the controller 312, and to complete the termination of service, the controller 312 sends the CHAN REL message 461 to the wireless communication device 104.

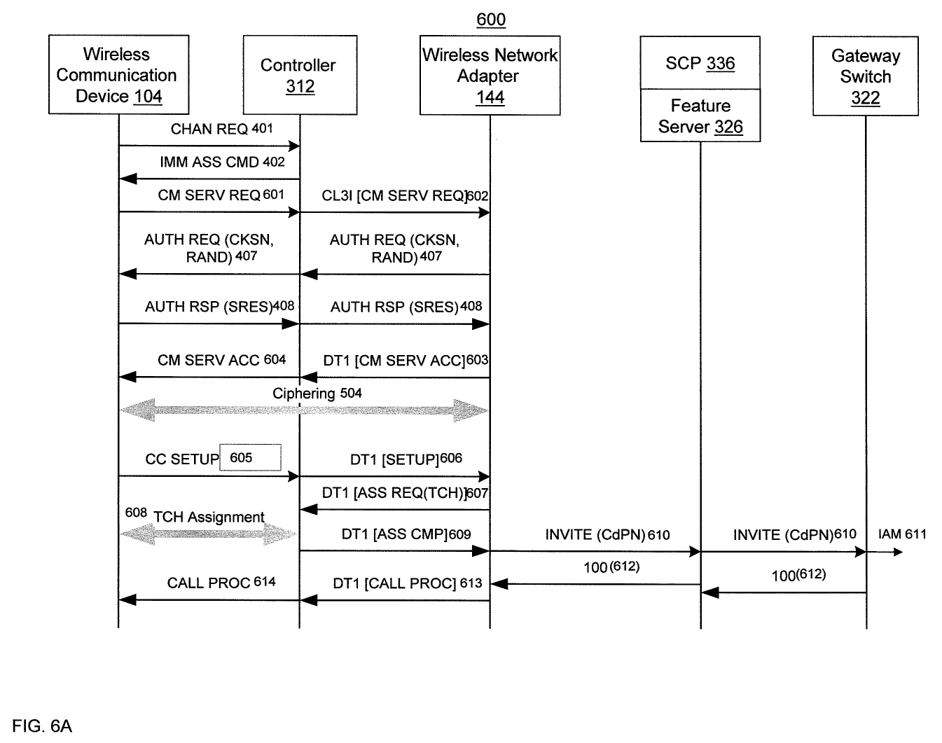

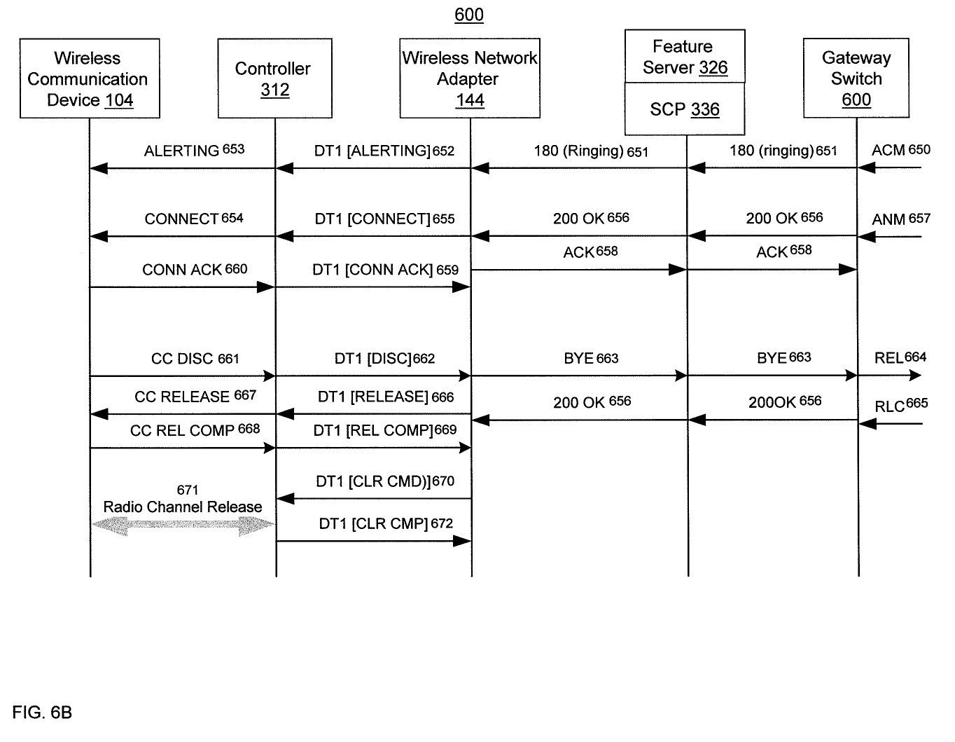

FIGS. 6A and 6B depict a process 600 illustrating the interaction of some components of FIG. 3 for a mobile origination (MO) call to a PSTN/Other Mobile Networks 220. FIGS. 6A and 6B incorporate some of the functionality illustrated in FIGS. 4A, 4B, and 5. Call set-up functionality, such as call control and routing logic, for example, resides with the SCP 336 and the feature server 326 (e.g. a PSX). The wireless network adapter 144 manages other aspects such as, for example, radio resource, location aspects, roaming aspects, and/or the like. For MO to PSTN/Other Mobile Networks 220, when the feature server 326 performs, for example, a policy dip, the SCP 336 does normal call routing without interacting with the location register 330. The SCP 336 returns the route to the gateway mobile switching center (GMSC), with the GMSC functionally embodied in the gateway switch 322 (e.g. a GSX) and SCP 336. GMSC functionality includes, for example, terminating PSTN signalling and traffic formats, converting the formats to protocols employed in mobile networks, interacting with the location register 330 for mobile termination (MT) calls to obtain routing information, and/or the like.

For media handling, the wireless network adapter 144 controls the media setup and teardown. The wireless network adapter 144 can use, for example, AMR compression when communicating with the wireless communication device 104, where for mobile to PSTN calls they would undergo a packet to packet (P2P) AMR-G.711 transcoding at the access node 140. Mobile to mobile calls, for example, are transcoder free operations (TrFO) calls, and the wireless network adapter 144 would negotiate CLEARMODE towards a peer wireless network adapter 144.

The wireless communication device 104 sends a CM SERVice REQuest message 601 to the controller 312, and the controller 312 passes the CM SERV REQ 601 to the wireless network adapter using the CL3I [CM SERV REQ] message 602, which contains, for example, the TMSI, IMSI, and/or the like. The CL3I [CM SERV REQ] can also be used to specify the type of service, for example, such as activation, Mobile Originating Call, Emergency Call, SMS, and/or the like. As with FIG. 4A, the authorization procedure is completed, and then the wireless network adapter 144 sends a DT1 [CM SERV ACCept] message 603 to the controller 312, and the controller 312 relays the information to the wireless communication device 104 using the CM SERV ACC message 604. This confirms to the wireless communication device 104 that the CM SERV REQ message 601 was processed and accepted by the switch 340. Ciphering 504 takes place as illustrated in FIG. 5.

The wireless communication device 104 transmits a Call Control SETUP message 605 to the controller 312. The CC SETUP (Called Party Number) message 605 may contain, for example, address information of the called party or the type of connection. The controller 312 relays the CC SETUP message 605 to the wireless network adapter 144 using the DT1 [SETUP] message 606. The wireless network adapter 144 sends a DT1 [ASSignment REQuest (Traffic CHannels)] message 607 to the controller 312 to assign a channel (e.g. the Air-interface or A-interface). In the TCH Assignment 608 phase, the controller 312 can select one TCH out of the available resources and assigns the TCH. The controller 312 sends a DT1 [ASSignment CoMPlete] message 609 to the wireless network adapter 144 as a positive response to the DT1 [ASS REQ(TCH)] message 607 (e.g. indicating the wireless communication device 104 has changed to the TCH and established a connection).

The wireless network adapter 144 sends an INVITE (CdPN) message 610 to the gateway switch 322 through the SCP 336 and feature server 326, to invite the particular CdPN for a connection. The INVITE (CdPN) message 610 contains, for example, the directory number of the called party. The gateway switch 322 transmits an Initial Address Message 611 out to the PSTN/other mobile networks 220 to set up the connection. The gateway switch 322 responds to the wireless network adapter 144 with a 100 message 612 relayed through the SCP 336 and feature server 326. The wireless network adapter 144 confirms with the DT1 [CALL PROCeeding] message 613 to the controller 312 that the IAM message 612 was successfully sent, and the controller 312 relays this information to the wireless communication device 104 using the CALL PROC message 614.

The process 600 of FIG. 6B is a continuation of the process 600 of FIG. 6A for the interaction of FIG. 3 components for a mobile origination (MO) call to a PSTN/Other Mobile Networks 220. The gateway switch 322 receives the Address Complete Message 650 from the PSTN/other mobile networks 220. The ACM 650 is part of the ISDN User Part (ISUP) and is responsible for the generation of a ring back tone at the wireless communication device 104. The gateway switch sends the 180 (ringing) message 651 indicative of the ring back tone to the wireless network adapter 144 through the SCP 336 and the feature server 326. The wireless network adapter 144 sends a DT1 [ALERTING] message 652 to the controller 312 indicating the MO call, which is sent to the wireless communication device 104 through the controller 312 in the ALERTING 653 message. The ALERTING 653 message is always sent to the initiating side of the call, which, by way of example, is the wireless communication device 104.

The gateway switch 322 receives the ISUP Answer Message from the PSTN/other mobile networks 220, which establishes the channel with the MSC of the PSTN/other mobile networks 220. The gateway switch 322 sends a 200 OK 655 message to the wireless network adapter 144 through the SCP 336 and feature server 326 to indicate receipt of the ANM. The wireless network adapter 144 sends a DT1 [CONNECT] message to the controller 312, resulting in the controller 312 sending the CONNECT message 657 to the wireless mobile subscriber. The CONNECT message 657 indicates to the wireless communication device 104, for example, that a connection was successfully established. The CONNection ACKnowledge message 658 is sent by the wireless communication device 104 to the controller 312 as an acknowledgment for the receipt of the CONNECT message 657. A call setup, for example, is regarded to be successful only after the CONN ACK message 658 is sent. The controller 312 sends the DT1 [CONN ACK] message 659 to the wireless network adapter 144 to convey the CONN ACK message 658. The wireless network adapter 144 sends the ACKnowlege message 660 to the gateway switch 322 through the SCP 336 and feature server 326.

To terminate the call, the wireless communication device 104 sends the CC DISC message 661 to the controller 312 to disconnect the CC connection. The CC DISC message 661 contains, for example, a cause value indicative of the reason why the call was disconnected. The controller 312 communicates the CC DISC message 661 to the wireless network adapter 144 using the DT1 [DISC] message 662. The wireless network adapter 144 sends the BYE message 663 to the gateway switch 322 through the SCP 336 and feature server 326. Upon receiving the BYE message 663, the gateway switch 322 sends the RELease message 664 to the PSTN/other mobile networks 220. The REL message 664 corresponds to, for example, an ISUP message responsible for terminating the connection. The PSTN/other mobile networks 220 confirms the release by sending a ReLease Complete message 665 to the gateway switch 322. The gateway switch 322 communicates receipt of the RLC 655 to the wireless network adapter 144 through the SCP 336 and feature server 326 with the 200 OK message 666. In response, the wireless network adapter 144 sends the DT1 [RELEASE] message 667 to the controller 312, and the controller 312 conveys the DT1 [RELEASE] message to the wireless communication device 104 using the CC RELEASE message 668. The CC RELEASE message 668, for example, is responsible for terminating the connection.

The wireless communication device 104 sends a CC RELease COMPlete message 669 to the controller 312 in response to the CC RELEASE message 668. The CC REL COMP message 669, for example, indicates the resources have been released. The controller 312 conveys the CC REL COMP message 669 to the wireless network adapter 144 using the DT1 [REL COMP] message 670. The wireless network adapter 144 responds to the DT1 [REL COMP] message 670 by sending the DT1 [CLeaR CoMmanD] message 671 to the controller 312. The DT1 [CLR CMD] message 671 is used to release the radio resources to the wireless communication device 104, which is done during the radio channel release 672. Upon completion of the radio channel release 672, the controller 312 sends the DT1 [CLeaR CoMPlete] message 673 to the wireless network adapter. The DT1 [CLR CMP] message 673 confirms the release of the resources.

For Mobile Termination (MT) calls, the gateway switch 322 and SCP 336 initiate the policy dip. The SCP 336 initiates a location register 330 query, which returns the address of the visiting mobile switching centre (VMSC) currently servicing the wireless communication device 104, which can correspond to the feature server 326 the wireless communication device 104 registered with, for example. For mobile to mobile calls, the feature server 326 initiates the policy dip and the SCP 336 queries the macro wireless network 205. Roaming MO and MT calls would originate, for example, from a visited public land mobile network (VPLMN). For a roaming MO call, where the wireless communication device 104 registered in the VPLMN, the call is routed based on information downloaded by the visiting MSC (VMSC) during a location update, for example. There would be no interaction with the access node network architecture 300. A MT call can also originate, for example, from the VPLMN when the call was originally from a PSTN/Other Mobile Networks 220, and the wireless communication device 104 roamed into the VPLMN. The gateway switch 322 initiates a query with a location registry (e.g. the location register of the macro wireless network 205) for the current location of the wireless communication device 104. Based on the response from the location registry, the gateway switch 322 routes the call to the appropriate serving VMSC. No interaction is necessary with the feature server 326 or the wireless network adapter 144. Advantageously, the wireless network adapter 144 appears, for example, like a BSC/MSC combination to a pico/femto BTS and emulates SIP endpoint behavior towards a core network. For example, the wireless network adapter can interwork GSM call control messages to SIP, handle MSC location procedures, and handle MSC handover procedures.

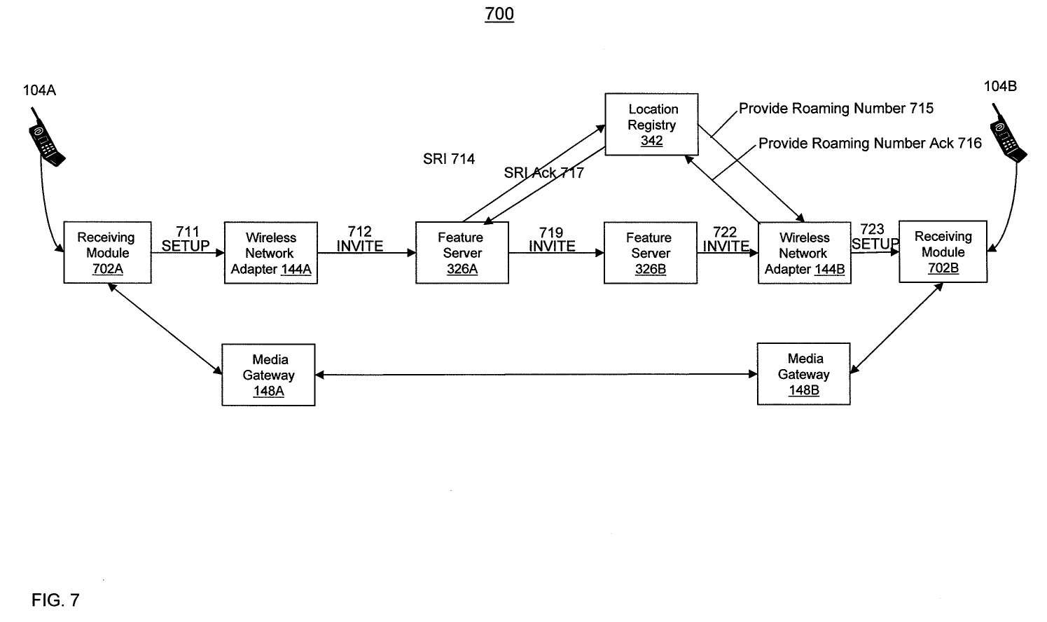

The system block diagram 700 of FIG. 7 shows an example of the interaction of FIG. 3 components for a wireless communication device 104A to wireless communication device 104B (generally, wireless communication device 104). There are two possibilities for a communication between both wireless communication devices 104, where they are either supported by feature server 326A and feature server 326B (generally, feature server 326, e.g. an ASX), or the same feature server, which would combine the interactions between feature server 326A, and feature server 326B. The communication contains a wireless network adapter 144A and a wireless network adapter 144B (generally, wireless network adapter 144), a media gateway 148A and a media gateway 148B (generally, media gateway 144, e.g. an MGW), and a receiving module 702A and a receiving module 702B (generally, receiving module 702). The receiving module 702 can be, for example, a base station, a BSC and/or a pico/femto access point. The receiving module 702 communicates with the media gateway 144 using, for example, AMR/RTP. The media gateway 148A communicates with the media gateway 148B using, for example, G.711/RTP.

The receiving module 702 sends a SETUP 711 command to the wireless network adapter 144. This can include, for example, the receiving module 702 sending a CM SERV REQ message to the wireless network adapter 144, authenticating, ciphering, the wireless network adapter 144 sending a CM SERV ACC message to the receiving module 702, and the receiving module 702 and wireless network adapter 144 establishing a traffic channel (TCH) assignment. The wireless network adapter 144 sends an INVITE 712 command to the feature server 326. The INVITE 712 can contain, for example, the CdPN. The feature server 326A sends a Send Routing Information 714 to the location registry 342, which can be in communication with the macro wireless network 205, to request the routing information for the wireless communication device 104B. The location registry 342, sends a provide roaming number message 715 to the wireless network adapter 144B, which is a message used by the location registry 342 to request reservation of a roaming number. The wireless network adapter 144B reserves the number and sends the provide roaming number acknowledgment 716 to the location registry 342 after the roaming number is reserved.

The location registry 342 sends an SRI acknowledgement 717 to the feature server 326A upon receiving the provide roaming number acknowledgment 716. The feature server 326A sends the INVITE (Mobile Subscriber Roaming Number) message 719 containing, for example, the MSRN. The feature server 326B sends the INVITE message 722 to the wireless network adapter 144B. The wireless network adapter 144B sends the SETUP message 723 to the receiving module 702B, which is used to inform the wireless communication device 104B about the necessary technical preconditions to accept the request, convey the identity of the calling wireless communication device 104A transparently to the wireless communication device 104B, and/or the like.

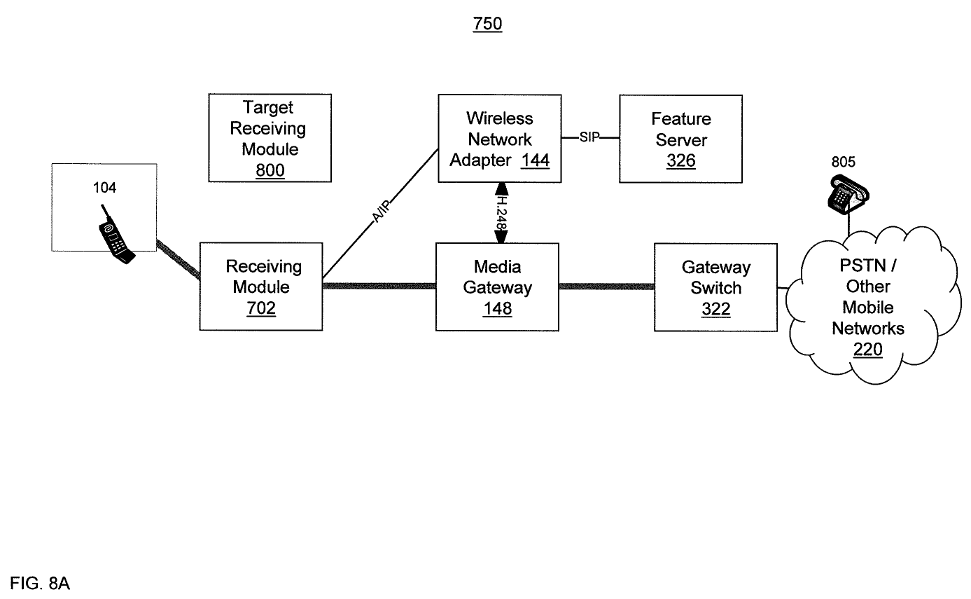

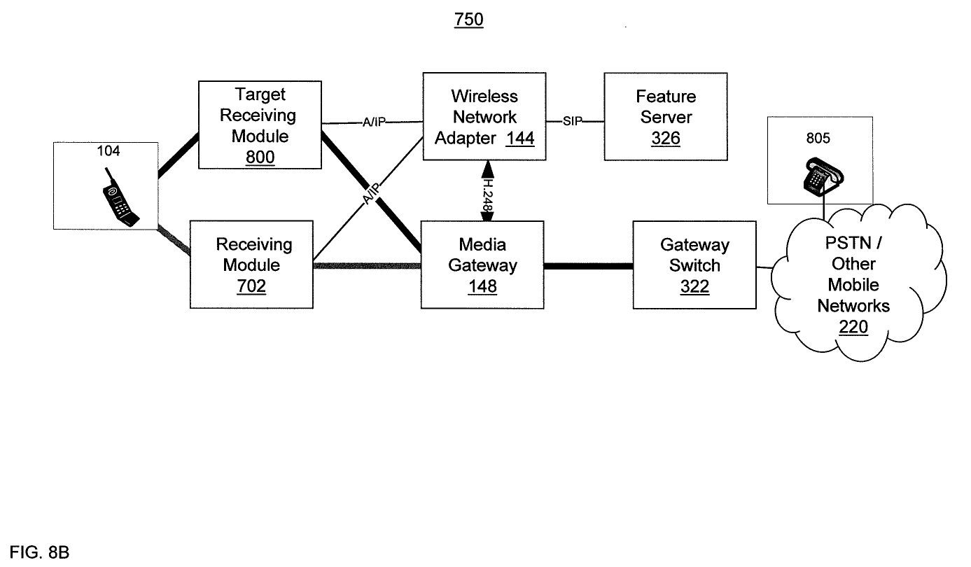

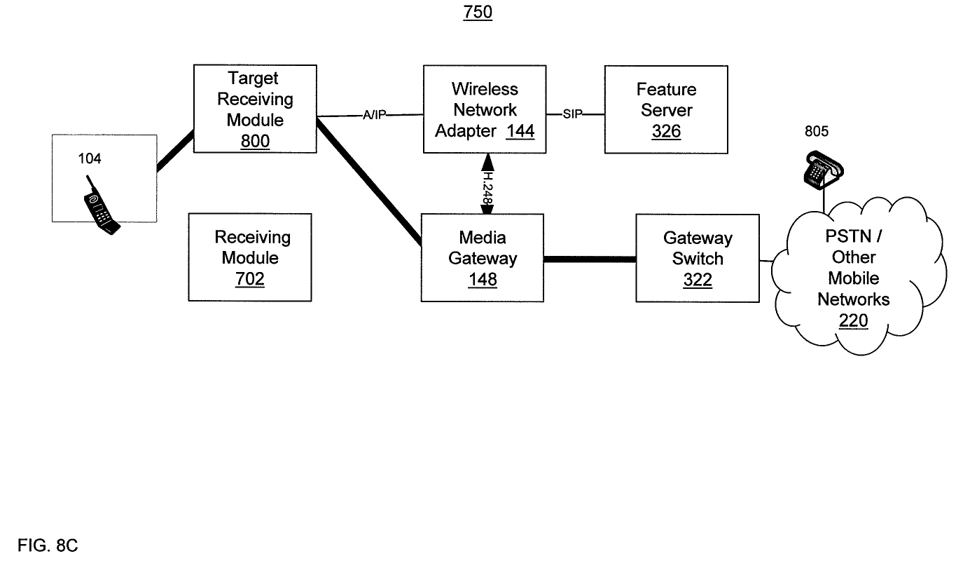

FIG. 8A-FIG. 8C illustrate the system block diagram 750 (comprising some of the components of FIG. 3) depicting an intra-MSC handover with the wireless communication device 104 in communication with a communication device 805. This could be, for example, a FemtoCell to FemtoCell HO. The wireless network adapter 144 handles the handovers in conjunction with the media gateway 148. For FemtoCell to FemtoCell handover, for example, each FemtoCell has its own radio resource management and acts like a BSC, and the wireless network adapter 144 handles it as an intra-BSC handover. For a FemtoCell/PicoCell to macroGSM handover, for example, the wireless network adapter 144 handles it as an inter-BSC handover.

The system block diagram 750 of FIG. 8A illustrates the communication before the handover occurs. The wireless communication device 104 is communicating with the receiving module 702 (e.g. a base station, a BSC, FemtoCell, and/or PicoCell as shown in FIG. 7). The receiving module 702 is in communication with the wireless network adapter 144 using, for example, the A or Iu interface protocol over the Internet protocol. The receiving module 702 is also in communication with the media gateway 148 using, for example AMR/RTP. The media gateway 148 is in communication with the wireless network adapter 144 directly using, for example, a media gateway control protocol, such as H.248. The media gateway 148 is also in communication with the gateway switch 322 using, for example, G.711/RTP. The gateway switch 322 (e.g. a GSX) bridges with the PSTN/Other Mobile Networks 220 using, for example, TDM. The wireless network adapter 144 communicates with the feature server 326 using, for example, SIP.

During the active phase of a call, the wireless communication subscriber 144 sends measurement reports to the receiving module 702. The receiving module 702 determines that a handover is required and sends a handover required message to the supporting switch 340 indicating the desired new base station. In order to reserve radio resources on the base station 304, the switch 340 sends a handover request to the target receiving module 800.

The system block diagram 750 of FIG. 8B illustrates the communication during the handover, where the media gateway 148 mixes audio streams. In addition to the communication path in FIG. 8A, the wireless communication device 104 is in communication with the target receiving module 800 in addition to the receiving module 702. The target receiving module 800 is in communication with the wireless network adapter 144 and the media gateway 148 using, similarly to FIG. 8B for example, IP over the A interface. The new base station (not shown) allocates resources required for handing off and sends a handover required acknowledgement with a handover command to the switch 340. On the air interface, the wireless communication device 104 performs a handover to the new cell and sends a HND ACC message to the new base station. The old base station maps the HND ACC message to a HND DET message towards the new base station, which sends the HND DET to the switch 340. The wireless network adapter 144 sets up the conference for the three terminations.

The system block diagram of FIG. 8C depicts the communication path after the handover has occurred, where the path to the receiving module 702 has been cleared. Once the wireless communication device 104 detects the handover is complete, the wireless communication device 104 sends a handover complete message to the new base station (not shown), which is forwarded to the switch 340 which initiates procedures to terminate the association between the old base station and the wireless communication device 104. The receiving module 702 no longer has a connection to either the wireless network adapter 144 or the media gateway 148. Instead the wireless communication device 104 is connected to the target receiving module 800, with the target receiving module 800 maintaining the connections as described in FIG. 8B.

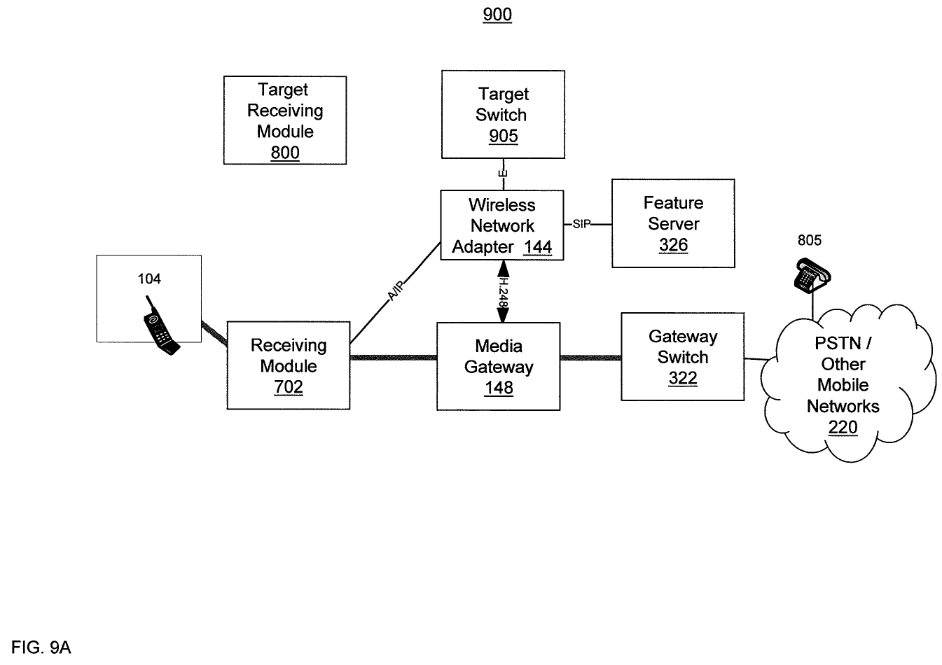

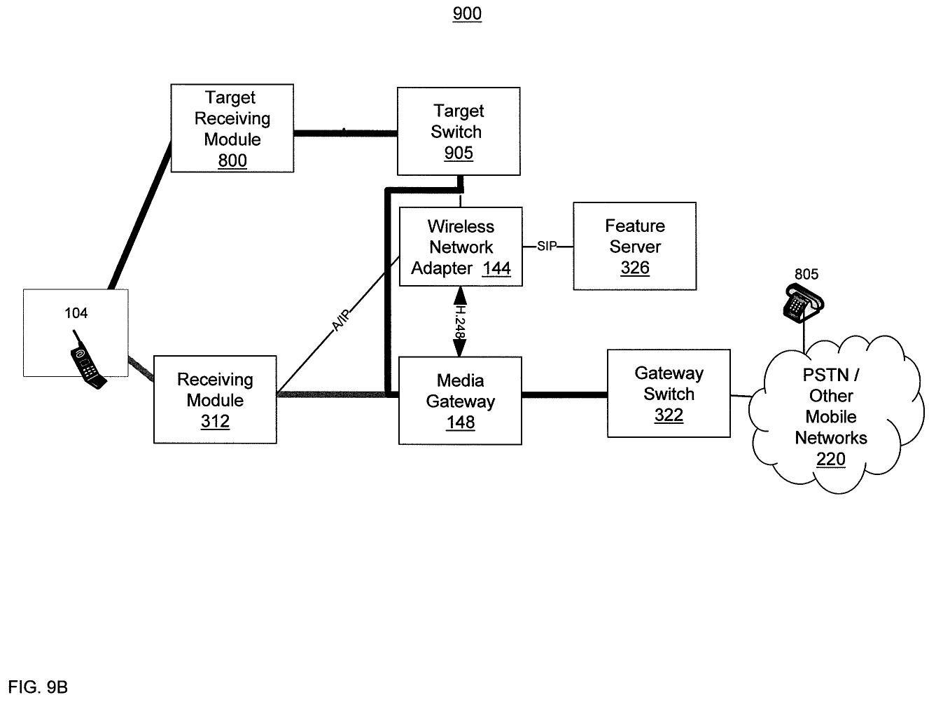

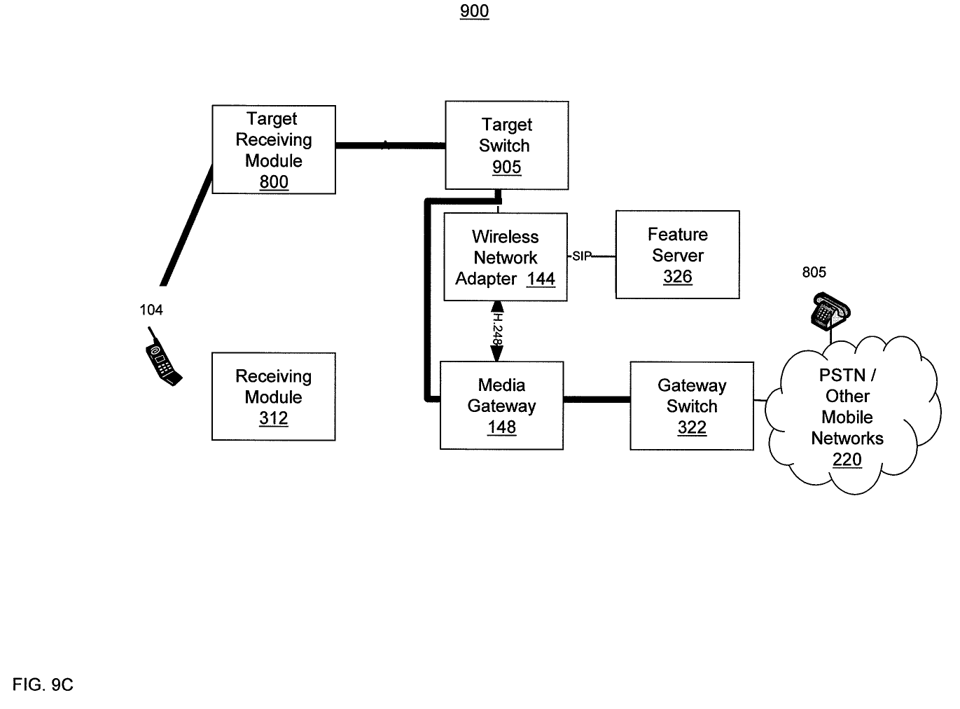

The system block diagram 900 of FIG. 9A-FIG. 9C depict an example of how the components of FIG. 3, based on FIG. 8A-FIG. 8C, interact during an inter-MSC handover with the wireless communication device 104 in communication with a communication device 805. This could be during, for example, a FemtoCell or PicoCell to Macro GSM Network HO.

The system block diagram 900 of FIG. 9A depicts network components and connections before a handover. For FIG. 9A, in addition to the communication in FIG. 8A, the target switch 905 is in communication with the wireless network adapter 144 using, for example, the MAP-E interface. The E interface is used, for example, to relay information during an inter-MSC handover coming from the A interface. The wireless communication device 104 is communicating with the receiving module 702. The receiving module 702 is in communication with the wireless network adapter 144 and the media gateway 148. The media gateway 148 is in communication with the wireless network adapter 144 and the gateway switch 322. The gateway switch 322 bridges with the PSTN/Other Mobile Networks 220. Additionally, the wireless network adapter 144 communicates with the feature server 326.

During the active phase of the call, the wireless communication device 104 sends measurement reports to the receiving module 702. The receiving module 702 determines, for example, that a handover is required and sends a handover required message to the switch 340, indicating the target base station. The receiving module 702 detects that the target area is controlled by a different target receiving module 800 (e.g. target BSC) and the receiving module 702 sends a prepare handover message to the target receiving module 800 using, for example, MAP. In order to reserve radio resources on the target base station (not shown), the target receiving module 800 sends a handover request to the target switch 905. The prepare handover response sent by the target receiving module 800 can contain, for example, a HO number and the handover command.

FIG. 9B is the system block diagram 900 of FIG. 9A illustrating the interaction of components during a handover. There is a new switch 340 to target switch 905 call, which is processed through the gateway switch 322 and feature server 326. The signaling between the switch 340 and target switch 905 can be, for example, MAP. The voice between the switch 340 and the target switch 905 can be, for example, TDM. The wireless communication device 104 is now in communication with the target receiving module 800. The target receiving module 800 is in communication with the target switch 905 using, for example, AMR/RTP.

Once the wireless network adapter 144 receiving the prepare handover response, the wireless network adapter 144 performs, for example, initiation of a call towards the target switch 905 using the HO number as the Called Party Number, sending the handover command to the wireless communication device 104 through the receiving module 702, and/or the like. On the A interface, the wireless communication device 104 performs, for example, a handover to the new base station and sends a handover accept message to the base station. The base station 304 maps the handover accept message to a handover detect message towards the new base station. The new base station sends the handover detect message to the target switch 905. The target switch 905 relays the handover detect message to the wireless network adapter 144 using, for example, MAP. The target switch 905 also sends an answer message for the receiving module 702 and target receiving module 800 call.

FIG. 9C is the same system block diagram 900 as 9A and 9B, further depicting the interaction of components after the HO has occurred. The wireless network adapter 144 sets up the conference for the three terminations. Once the wireless communication device 104 detects that the handover is complete, the wireless communication device 104 sends a handover complete message to the target receiving module 800. The handover complete message is forwarded by the target receiving module 800 to the wireless network adapter 144, and the wireless network adapter 144 sends a handover complete message to the target receiving module 800. The handover complete message is forwarded by the target switch 905 to the wireless network adapter 144 which initiates, for example, procedures to terminate the radio resource (RR) management association between the old receiving module 702 and the wireless communication device 104. The path to the old base station is cleared. The switch 340 retains CC. The target switch 905 retains relays all CC messages.

Referring to FIG. 3, the access node provides services such as, for example, call forwarding, call waiting, call hold, call transfer, multi-party call, voice mail notification, emergency calling, line identification services, call completion, call barring, prepaid calling, and/or the like. Other supplementary services can include enhanced multi-level precedence and preemption (eMLPP), advice of charge, FollowMe, closed user group (CUG) calls, and/or the like. Advantageously, the media gateway 148 can, for example, anchor voice and provide packet to packet TrFO or AMR-G.7xx flows, provide for n-way features for handovers, insert inband tines (e.g. call waiting, mid-call DTMF), provide support for CALEA, and provide for transcoder rate adaptation unit (TRAU) functions.

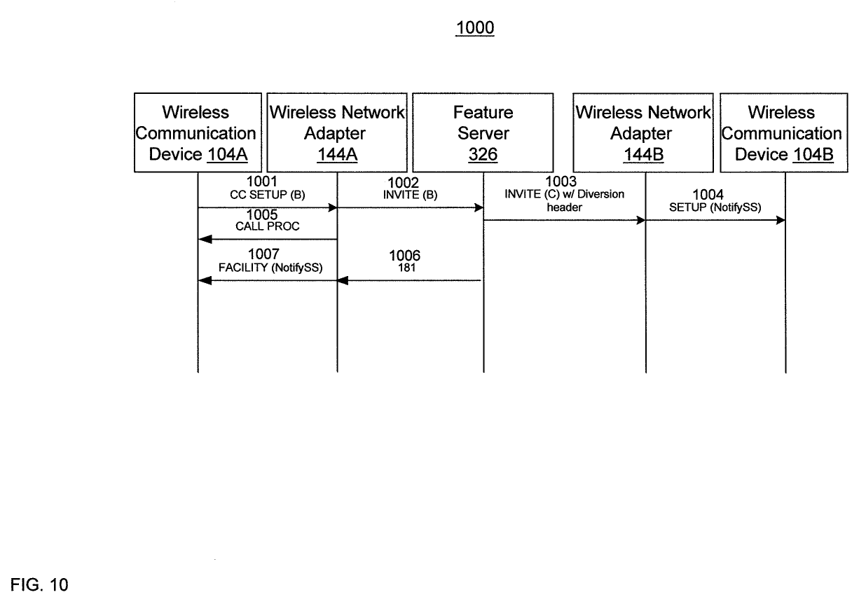

FIG. 10 depicts a process 1000 illustrating the interaction of some of the FIG. 3 components during a MO call from a wireless communication device 104A forwarded to a wireless communication device 104B. Call forwarding can be implemented using, for example, the Third Generation Partnership Project (3GPP). The 3GPP defines, for example, call forwarding unconditional (CFU), call forwarding on mobile subscriber busy (CFB), call forwarding not reachable (CFNR), call forwarding no answer (CFNA), and/or the like. Procedures such as registration, erasure, activation, deactivation, interrogation, and/or the like are provided using a REGISTER message. The feature server 326 defines such procedures using, for example, vertical service codes (VSC), web-based interface to the feature server 326, and/or the like. The wireless network adapter 144 maps, for example, REGISTER messages from the wireless communication device 104 to web-portal based interaction towards the feature server 326. The wireless network adapter 144 could also, for example, map REGISTER into INVITE towards an ASX (not shown) with appropriate VSC.

The components of FIG. 10 include a wireless network adapter 144A and wireless network adapter 144B (generally, wireless network adapter 144). The wireless communication device 104A sends a CC SETUP (B) message 1001 to the wireless network adapter 144A to originate the call. The wireless network adapter 144A sends the INVITE(B) message 1002 to the feature server 326. 3GPP requires, for example, the forwarded-to wireless communication device 104B to be notified of the call forwarding. The feature server 326 provides an INVITE (C) with diversion header message 1003. The wireless network controller 144 can, for example, map the INVITE (C) w/ division header message 1003 into NotifySS and send the NotifySS in the SETUP(NotifySS) message 1004 to the wireless communication device 144B. 3GPP requires, for example, when wireless communication device 104A has call forwarding active and tries to originate a call, an indication is given to the wireless communication device 104A that call forwarding is active. The wireless network adapter 144 provides the indication.

The wireless network adapter 144A sends a CALL PROCeeding message 1005 to the wireless communication device 104A. The CALL PROC message 1005 is a confirmation of the CC SETUP (B) message 1001 sent by the wireless communication device 1001 to the wireless network adapter 144A. 3GPP requires, for example, the calling wireless communication device 104A to be notified of call forwarding. The feature server 326 would provide, for example, a “181-Call is being forwarded” message 1006 to the wireless network adapter 144A. The wireless network adapter 144A provides the mapping for the “181-Call is being forwarded” message to a FACILITY (NotifySupplementaryService) message 1007, and transmits the FACILITY (NotifySS) message 1007 to the wireless communication device 104A.

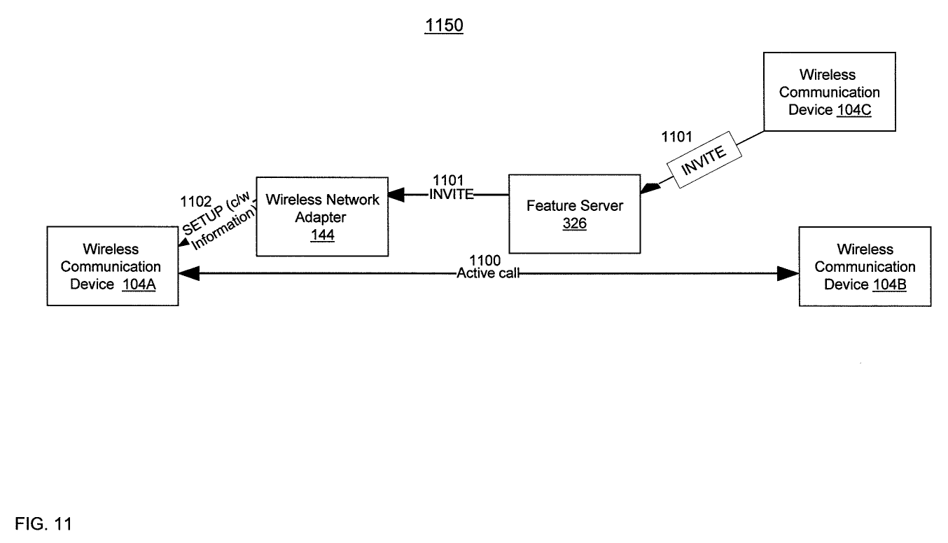

FIG. 11 illustrates a block diagram 1150 depicting the interaction of some of the FIG. 3 components for a call waiting service. This can be implemented using 3GPP, for example, which has an option to alert the calling wireless communication device 104C that the call is kept waiting. For the call waiting service to be initiated, there is an active call 1100 between wireless communication device 104A and wireless communication device 104B. The wireless communication device 104C sends an INVITE message 1101 to the wireless network adapter 144 through the feature server 326. The wireless communication device 144 maps the INVITE message 1101 to the SETUP with, for example, a signal information element, encapsulated in the SETUP (c/w information) message 1002.

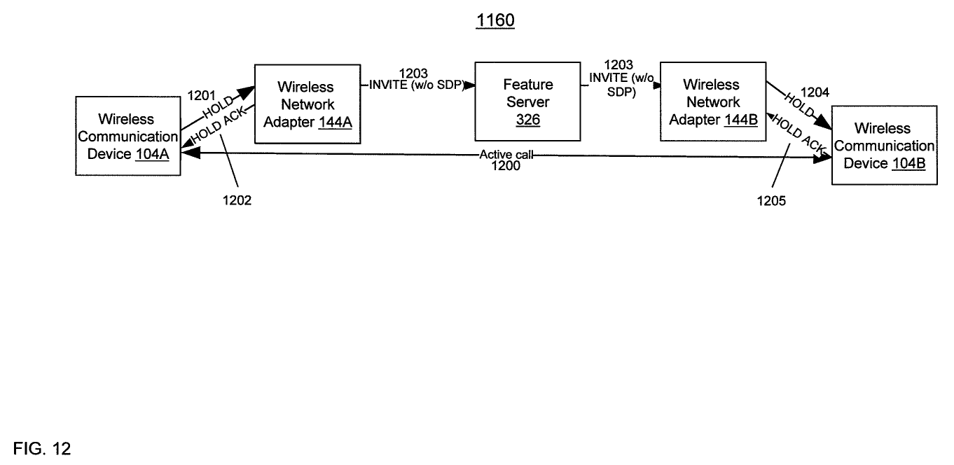

FIG. 12 illustrates a block diagram 1160 depicting the interaction of FIG. 3 components for a call hold, with an active call 1200 between wireless communication device 104A and wireless communication device 104B. 3GPP, for example, defines HOLD for a call hold supplemental service. The other party is notified of the call hold by a FACILITY message. A FACILITY message contains, for example, transparent data for supplementary services. SIP, for example, implements call hold using Re-INVITE and a null SDP. In FIG. 12, the wireless communication device 104A sends a HOLD message 1201 to the wireless network adapter 144A, and the wireless network adapter 144A responds with an HOLD ACKnowledgment message 1202 to the wireless communication device 104A. The wireless network adapter 144A transmits the reINVITE (without SDP) message 1203 to the feature server 326, and the feature server 326 transparently passes the INVITE (without SDP) message 1203 to the wireless network adapter 144B. The wireless network adapter 144B sends a HOLD message 1204 to the wireless communication device 104B to signal the call hold. In receipt of the HOLD message 1204, the wireless communication device 104B responds to the wireless network adapter 144B with a HOLD ACKnowledgment message 1205. The wireless network adapter 144A and wireless network adapter 144B map, for example, Re-INVITE into HOLD and RETRIEVE.

Referring back to FIG. 3, for a call transfer, the feature server 326 supports call transfer. The feature server, for example, supports call transfer using the SIP REFER method. In order to transfer a call, the wireless network adapter 144 maps the FACILITY message with ECT request from the wireless communication device 104 to a SIP REFER method. At the point of initiation of the transfer, both calls between the wireless communication device 104 and a second wireless communication device 104A and the wireless communication device 104 and a third wireless communication device 104B should have been answered. After the transfer, media flows directly between the second wireless communication device 104A and the third wireless communication device 104B.

The feature server 326 supports a multi-party call. The wireless network adapter 144 maps the FACILITY (Multi Party Service (MPTY) invocation) into the SIP INFO message. MPTY allows, for example, the served subscriber to establish a conference call with multiple parties. For voice mail, the service is essentially provided by the voice mail server of the macro wireless network 200. For example, incoming calls are forwarded to the voice mail server by using the call forwarding service, and the user can dial into the voice mail server to check his or her voice mail. The feature server 326 provides message waiting indication to the appropriate SIP endpoint for the voice mail server, and the SIP endpoint subscribes to the feature server 326 service using, for example, the SIP SUBSCRIBE. The wireless network adapter 144 would need to support the SIP SUBSCRIBE method towards the feature server 326 for all wireless communication device 104 subscribers who have voice mail service. Upon receiving a SIP NOTIFY, for example, the wireless network adapter 144 would need to initiate the notification of the wireless communication device 104 subscriber.

For an emergency calling service from the wireless communication device 104, the feature server 326 and gateway switch 322 would handle the emergency call. The feature server 326 includes the Calling Party Category protocol in the P-Asserted-Identity header in the INVITE towards the gateway switch 322, and the gateway switch 322 connects to the appropriate emergency service, such as E-911, for example. On the wireless communication device 104 disconnects, the feature server 326 responds to the disconnect but does not tear down the network call leg.

For line identification services, the feature server 326 supports, for example, Call Line Identification Procedure (CLIP) and Call Line Identification Restricted (CLIR). The wireless network adapter 144 would support mapping SIP parameters to, for example, 24.0008 parameters. For a busy subscriber for call completion, the feature server 326 supports Ring Back When Free (RBWF). Call barring would be supported by the SCP 336, which would implement call blocking, call screening, and/or the like. For prepaid calling, prepaid subscribers could be supported using customized application of mobile network enhanced logic (CAMEL), SIP prepaid service, and/or the like. CAMEL based prepaid calling involves the CAMEL application part (CAP) interactions with the Service Control Point (SCP) based on criteria specified in the CAMEL Subscription Service (CSI). CSI is provided by the location register 342 of the macro wireless network 205. The serving switch 340 gets the CSI in the MAP communication at the time of the wireless communication device 104 registration. The gateway switch 322 and SCP 336 support CAMEL processing based on CSI, prepaid service for MT calls, and/or the like. SIP prepaid service, for example, would be implemented by the core network 240. The wireless network adapter 144 and the location register 330 map the CAP/MAP procedures to the SIP procedures.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include and can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The communication device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®. The IP phone includes, for example, a Cisco® Unified IP Phone 7985G available from Cisco System, Inc, and/or a Cisco® Unified Wireless Phone 7920 available from Cisco System, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of creating a unified wireline/wireless communication network, the method comprising:
receiving data that includes a signaling portion and a media portion; and
separating the signaling portion into a first set of data and a second set of data,
wherein the first set of data includes mobility management functions and the second set of data includes features, applications related functions, or any combination thereof.

2. The method of claim 1, further comprising receiving the data over a network, wherein the network comprises an IP network.

3. The method of claim 2, wherein a base station is in communication with the network.

4. The method of claim 3, wherein the base station comprises a picocell or femtocell base station.

5. The method of claim 1, further comprising transmitting the first set of data to a mobile wireless network using a protocol associated with a wireless telecommunication standard.

6. The method of claim 5, wherein the protocol associated with the wireless telecommunication standard includes GSM-MAP, ANSI IS-41, or any combination thereof.

7. The method of claim 5, wherein the mobile wireless network is a GSM network.

8. The method of claim 1, further comprising transmitting the second set of data to a core network using a protocol associated with a packet communication technology.

9. The method of claim 8, wherein the protocol associated with the packet communication technology includes SIP, RTP, RTCP, AMR, or any combination thereof.

10. The method of claim 8, wherein the core network emulates cellular core network components towards an external network.

11. The method of claim 10, wherein the core network supports a service provided by a mobile communication network.

12. The method of claim 11, wherein the service includes call forwarding, call waiting, call hold, call parking, simultaneous ringing, call transfer, multi-party calling, voice mail notification, emergency calling, call completion busy, call barring, or any combination thereof.

13. The method of claim 1, further comprising transmitting the media portion to a server using packet communication technology.

14. The method of claim 13, wherein the media portion comprises voice portions of the data, inband tones of the data, other functions that are communicated across the telephone communication network to a media gateway, or any combination thereof.

15. A computer program product, tangibly embodied in an information carrier, the computer program product including instructions being operable to cause a data processing apparatus to:
receive data that includes a signaling portion and a media portion; and
separate the signaling portion into a first set of data and a second set of data,
wherein the first set of data includes mobile management functions and the second set of data includes features, applications related functions, or any combination thereof.

16. A system for creating a unified wireline/wireless communication network, the system comprising:
an access node configured to receive data that includes a signaling portion and a media portion; and
a wireless network adapter configured to separate the signaling portion into a first set of data and a second set of data, where the first set of data includes mobile management functions, and where the second set of data includes features, applications related functions, or any combination thereof.

17. The system of claim 16, further comprising at least a portion of a mobile wireless network configured to receive a first set of data from the wireless network adapter, the at least portion of the mobile wireless network being in communication with the wireless network adapter using a protocol associated with a wireless telecommunication standard.

18. The system of claim 16, further comprising at least a portion of a core network configured to receive a second set of data from the wireless network adapter, the at least portion of the core network being in communication with the wireless network adapter using a protocol associated with a packet communication technology.

19. The system of claim 16, wherein the wireless network adapter is further configured to transmit the first set of data to a mobile wireless network and transmit the second set of data to a core network.

20. The system of claim 16, further comprising a media gateway configured to receive the media portion of the data, generate a third set of data, and transmit the third set of data to a telephone communication network in communication with the media gateway using a protocol associated with a packet communication technology.

21. The system of claim 20, wherein the third set of data comprises voice portions of the data, inband tones of the data, other functions that are communicated across the telephone communication network to a media gateway, or any combination thereof.

22. The system of claim 16, wherein the wireless network adapter is further configured to work with at least a portion of a core network to emulate a MSC and a VLR.

23. A system for creating a unified wireline/wireless communication network, the system comprising:
a means for receiving data that includes a signaling portion and a media portion;
a means for separating the signaling portion into a first set of data and a second set of data, where the first set of data includes mobile management functions, and where the second set of data includes features, applications related functions, or any combination thereof.

24. A system for creating a unified wireline/wireless communication network, the system comprising:
an access node configured to receive data that includes a signaling portion and a media portion;
a wireless network adapter configured to separate the signaling portion into a first set of data and a second set of data, where the first set of data includes mobile management functions, and where the second set of data includes features, applications related functions, or any combination thereof, the wireless network adapter using mobile wireless network communication functionality.

25. The system of claim 24, wherein mobile wireless network communication functionality includes MSC, HLR, VLR, AUC, TRAU, IWF, SGSN, GGSN, BSC, BTS, or any combination thereof.
